(19) United States
(12) Patent Application Publication
(10) Pub. No.: US 2010/0114854 A1
(43) Pub. Date: May 6, 2010

(54) MAP-BASED WEBSITES SEARCHING METHOD AND APPARATUS THEREFOR

(75) Inventor: Moon-sang LEE, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/471,604

(22) Filed: May 26, 2009

(30) Foreign Application Priority Data
Oct. 27, 2008 (KR) 2008-105488

(51) Int. Cl. G06F 17/30; G01S 1/00

(52) U.S. Cl. 707/707; 342/357.06; 707/E17.108; 707/E17.032; 707/E17.019

(57) ABSTRACT

A web searching method and a terminal for the web searching method, the web searching method including: extracting map information about a specific geographic area that is designated via a map displayed on a screen of the terminal; requesting a server to perform a web search related to the specific geographic area according to the map information; receiving a link information list from the server and displaying the link information list on the screen, wherein the link information list is about a plurality of web pages matched with the map information about the specific geographic area; and browsing a web page corresponding to link information selected from among the link information list.

### CROSS-REFERENCE TO RELATED APPLICATION

This application claims the benefit of Korean Patent Application No. 10-2008-0105488, filed on Oct. 27, 2008 in the Korean Intellectual Property Office, the disclosure of which is incorporated herein in its entirety by reference.

### BACKGROUND OF THE INVENTION

1. Field of the Invention

Aspects of the present invention relate to a website searching method (hereinafter, referred to as a “web searching method”) and apparatus therefor, and more particularly, to a map-based web searching method and apparatus therefor that allow a client device having a limited input/output interface to easily view web pages.

2. Description of the Related Art

In general, most users of the Internet access the Internet via a browser of a personal computer (PC) and search for information via Internet portal websites, etc. When a user inputs a keyword in a search box of an internet portal website, the internet portal website extracts various kinds of information corresponding to the keyword from a database, and provides the information to the user.

Currently, web pages are searched for by using a user input keyword. However, unlike PCs, it is difficult for client devices not having a keyboard or including only a limited input/output interface to perform a conventional text-based web search. Thus, such client devices need to have an operation capable of searching for web pages by using a simple user interaction on a touch screen or by manipulating direction keys.

### SUMMARY OF THE INVENTION

Aspects of the present invention provide a map-based web searching method and apparatus therefor that allow a client device having a limited input/output interface to easily view web pages.

According to an aspect of the present invention, there is provided a web searching method performed by a terminal, the web searching method including: extracting map information about a specific geographic area that is designated via a map displayed on a screen of the terminal; requesting a server to perform a web search related to the specific geographic area according to the map information; receiving a link information list from the server and displaying the link information list on the screen, wherein the link information list relates to one or more web pages matched with the map information about the specific geographic area; and browsing a web page, of the one or more web pages, corresponding to link information selected from the link information list.

According to another aspect of the present invention, there is provided a web searching method performed by a server, the web searching method including: collecting a plurality of web pages on the Internet; extracting position information about each of the plurality of web pages from one or more images comprised in each web page, and generating a position-based index for each of the web pages according to the position information; comparing the position-based index for each of the web pages with map information about a specific geographic area selected by a terminal to search for web page link information matching the map information about the specific geographic area in order to generate a link information list about one or more web pages corresponding to the specific geographic area; and providing the link information list to the terminal.

According to yet another aspect of the present invention, there is provided a terminal for web searching, the terminal including: an input unit to receive a user command; a storage unit to store map information; a display unit to display the map information and web page data; and a control unit to generate a query message according to map coordinates of a specific geographic area that is selected via the input unit and that is in a map displayed in the display unit, to receive a link information list from a server, and to display the link information list on the display unit, wherein the link information list is about one or more web pages matched with map information about the specific geographic area.

According to still another aspect of the present invention, there is provided a server for web searching, the server including: a web page collecting unit collecting a plurality of web pages on the Internet; a web page index generating unit to extract position information from one or more images comprised in each of the plurality of web pages collected by the web page collecting unit, and to generate position-based indexes for each of the plurality of web pages according to the position information; and a web searching unit to search for a link information list about one or more web pages, of the plurality of web pages, having a position-based index that is matched with map coordinates of a specific geographic area, when a query message about the map coordinates of the specific geographic area is received from a terminal.

According to another aspect of the present invention, there is provided a system for web searching, the system including: a terminal to transmit a query message including a specific geographic area, the terminal including: an input unit to receive an input of a user command, a storage unit to store map information, a display unit to display the map information and web page data, and a control unit to generate the query message including the specific geographic area that is selected via the input unit from the map information displayed on the display unit, to receive a link information list in response to the query message, and to display the link information list; and a server to transmit the link information list about one or more web pages corresponding to the specific geographic area, when the query message including the specific geographic area is received from the terminal, the server including: a web page collecting unit to collect a plurality of web pages on the Internet, a web page index generating unit to extract position information about each of the plurality of web pages from one or more images comprised in each of the plurality of web pages, and to generate a position-based index for each of the plurality of web pages according to the corresponding position information, and a web searching unit to compare the position-based index for each of the plurality of web pages with map information about the specific geographic area included in the query message received from the terminal in order to generate the link information list about the one or more web pages, of the plurality of web pages, corresponding to the specific geographic area.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a map-based web searching system according to an embodiment of the present invention;

FIG. 2 is a detailed block diagram of a web searching server in FIG. 1;

FIG. 3 is a detailed block diagram of a terminal in FIG. 1;

FIG. 4 is a flowchart of a map-based web searching method, according to an embodiment of the present invention;

FIG. 5 is a flowchart of a position-based index database generating method performed by a web searching server, according to another embodiment of the present invention; and

FIG. 6 is a flowchart of a position-information-based web searching method performed by the web searching server, according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

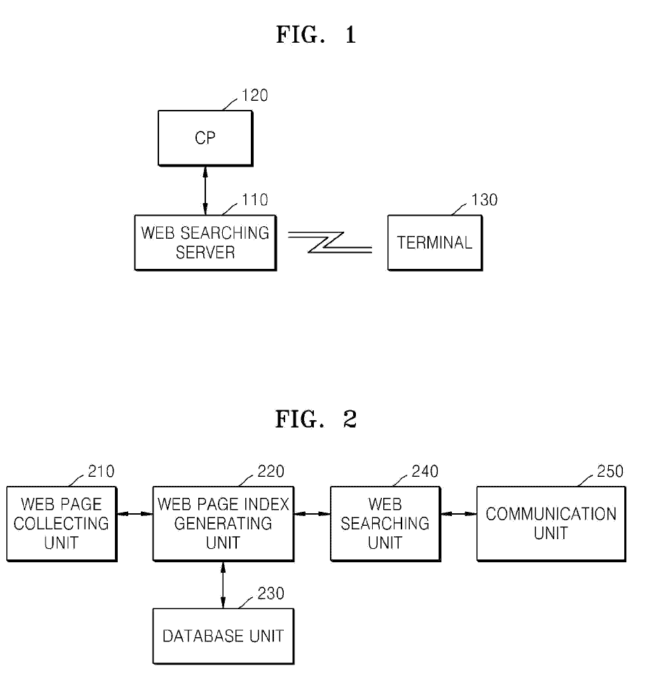

FIG. 1 is a block diagram of a map-based web searching system according to an embodiment of the present invention. Referring to FIG. 1, the map-based web searching system of FIG. 1 includes a web searching server 110, a contents provider (CP) 120, and a terminal 130.

The CP 120 contains a plurality of pieces of web page data, and provides web page data corresponding to an information request from the web searching server 110. For example, Hyper Text Markup Language (HTML) data described by using an HTML form, and image data related to the HTML data are defined as “web page data.” The image data of a web page includes position information (such as Global Positioning System (GPS) information about latitude, longitude, altitude, etc.).

The web searching server 110 collects data of web pages that are on the Internet and provided from the CP 120 by using a web crawler, extracts position information from image data contained in the web pages, generates a position-based index for the web pages according to the position information, and stores the position-based index in a database. Accordingly, when the terminal 130 requests the web searching server 110 to perform a web search related to a specific area, the web searching server 110 provides the terminal 130 with a link information list (e.g., a Uniform Resource Locator (URL) list about web pages) classified to the specific area.

The terminal 130 receives map information from a map server (not shown), displays the map information on a screen, generates a web search query message according to map information about a specific area selected via a user interaction on a map or via manipulation of direction keys, and displays the URL list about the web pages on the screen. In particular, the web pages are matched with map information about the specific area received from the web searching server 110, and the user browses a web page of a URL selected from among the URL list about the web pages on the screen. The map server (not shown) provides map databases to the terminal 130.

FIG. 2 is a detailed block diagram of the web searching server 110 in FIG. 1. Referring to FIG. 2, the web searching server 110 includes a web page collecting unit 210, a web page index generating unit 220, a database unit 230, a web searching unit 240, and a communication unit 250. The web page collecting unit 210 collects a plurality of web pages on the Internet by using a web crawler. The web page index generating unit 220 extracts position information (such as GPS coordinate information) from a plurality of pieces of image data in the collected web pages, and generates a position-based index for each of the web pages according to the GPS coordinate information (provided hereinafter as an example of the position information). The database unit 230 stores each position-based index corresponding to each of the web pages and generated by the web page index generating unit 220.

When the terminal 130 requests the web searching unit 240 for a query about map coordinates of a specific area, the web searching unit 240 searches for a URL list of web pages matched with the position-based index, that is generated by the web page index generating unit 220, with respect to map coordinates of the specific area. Accordingly, the web searching unit 240 provides the terminal 130 with the URL list of the web pages. The communication unit 250 performs wired and/or wireless Internet communication with the terminal 130.

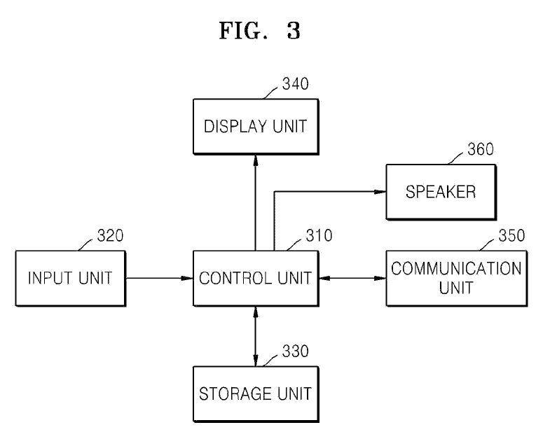

FIG. 3 is a detailed block diagram of the terminal 130 in FIG. 1. Referring to FIG. 3, the terminal 130 includes a control unit 310, an input unit 320, a storage unit 330, a display unit 340, a communication unit 350, and a speaker 360. The input unit 320 inputs a user command via an input/output interface (including, for example, a plurality of key modules, a touch screen, and/or a rotatable dial). The storage unit 330 may be a flash memory or a hard disc drive (HDD), and stores a control program to drive the control unit 310, various multimedia contents, and map data. The display unit 340 may be embodied as a touch screen, a cathode-ray tube (CRT), and/or a liquid crystal display (LCD), and displays various kinds of information in correspondence to operations of the control unit 310 by using a pop-up window or graphics. The communication unit 350 performs wired and/or wireless Internet communication with the web searching server 110. The speaker 360 reproduces an audio signal output from the storage unit 330 or the control unit 310 as sound.

The control unit 310 transmits a query message to the web searching server 110, wherein the query message relates to a web search within an area of interest according to map coordinates of the area of interest that is selected, via the input unit 320, from a map displayed on the display unit 340. In response, the control unit 310 receives a URL list about web pages from the web searching server 110, wherein the web pages are matched with the map coordinates of the area of interest. Accordingly, the control unit 310 displays the URL list on the display unit 340, and browses a web page selected from the URL list. Also, the control unit 310 receives updated map data from a map server (not shown) via the communication unit 350, thereby storing the updated map data in the storage unit 330.

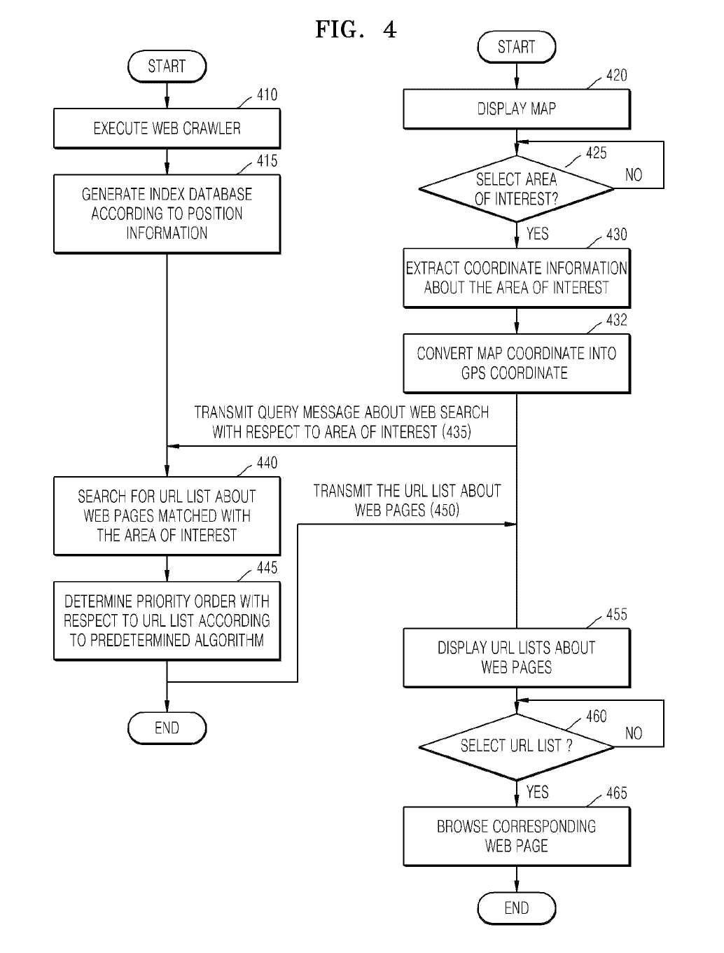

FIG. 4 is a flowchart of a map-based web searching method, according to an embodiment of the present invention. Referring to FIG. 4, a web searching server 110 executes a software agent (that is, a program) referred to as a web crawler in operation 410. The web searching server 110 collects a plurality of web pages on the Internet by using the web crawler, and generates an index database about the web pages according to position information extracted from a plurality of pieces of image data included in the web pages in operation 415.

Meanwhile, a terminal 130 displays a map on a screen (such as a touch screen) in operation 420. At this time, the terminal 130 collects map information from a map server (not shown). The terminal 130 checks whether a user selects an area of interest in the map displayed on the screen in operation 425. As an example, the user may draw a polygon on the map displayed on the touch screen of the terminal 130 to select the area of interest. Accordingly, the terminal 130 may recognize the area of interest by referring to the polygon that is drawn by the user. However, it is understood that aspects of the present invention are not limited thereto. For example, in the case of the terminal 130 including a TV screen that is not a touch screen, the terminal 130 may recognize the area of interest by referring to a polygon having a predetermined size and shape (e.g., one lattice area from among an entire area that is divided into a plurality of square-shaped lattice areas and is displayed). Also, the user may designate one point on the map, and the one point on the map may represent an area having a predetermined radius centered from the point. Furthermore, the user may select the area of interest by inputting map coordinates.

The terminal 130 extracts representative coordinate information about the area of interest in operation 430. For example, the terminal 130 may extract a representative map coordinate value in an area of the polygon selected by the user. The terminal 130 converts the representative coordinate information about the area of interest into GPS coordinates in operation 432. The terminal 130 generates a query message about a web search with respect to the area of interest by using a map parameter including the GPS coordinates of the area of interest. Then, the terminal 130 transmits the generated query message to the web searching server 110 in operation 435. At this time, the terminal 130 may generate the query message about the web search by using a parameter including map coordinates of the area of interest.

The web searching server 110 compares the map parameter of the area of interest that is received from the terminal 130, with a web page index stored in the index database, and searches for a URL list of web pages matched with the area of interest in operation 440. For example, the web searching server 110 searches for indexes about a web page corresponding to the GPS coordinates of the area of interest that is received from the terminal 130.

The web searching server 110 determines a priority order with respect to a link information list (e.g., the URLs of the web pages) according to a predetermined algorithm in operation 445. Here, the predetermined algorithm includes various web page evaluating algorithms such as a PageRank algorithm of Google. The web searching server 110 transmits the URL list of the web pages to the terminal 130 in operation 450, wherein the URLs are arranged according to the priority order that is determined (operation 445). For example, the web searching server 110 first transmits a top-ranked (i.e., highest priority) URL from among the URL list to the terminal 130.

Next, the terminal 130 displays the URL list of the web pages received from the web searching server 110 on a screen in operation 455. Specifically, the terminal 130 displays the URL list of the web pages according to the priority order determined by the web searching server 110, though aspects of the present invention are not limited thereto. For example, according to another aspect, the terminal 130 may re-arrange the URL list of the web pages according to a previous browsing history. Moreover, the terminal 130 may group the URLs of the web pages into categories, or may classify the URL list of the web pages according to a user's profile or a user preference. Here, the user preference may be determined from text in the web pages or from metadata.

The terminal 130 checks whether the user selects one or more URLs from among the URL list displayed on the screen in operation 460. The user uses the terminal 130 to browse web pages of the one or more URLs on the screen in operation 465.

According to the embodiment of FIG. 4, it is possible to perform the web search by selecting an area of interest without inputting a keyword so that a desired web page may be searched for via a simple user interaction on the touch screen or via manipulation of 4-direction keys.

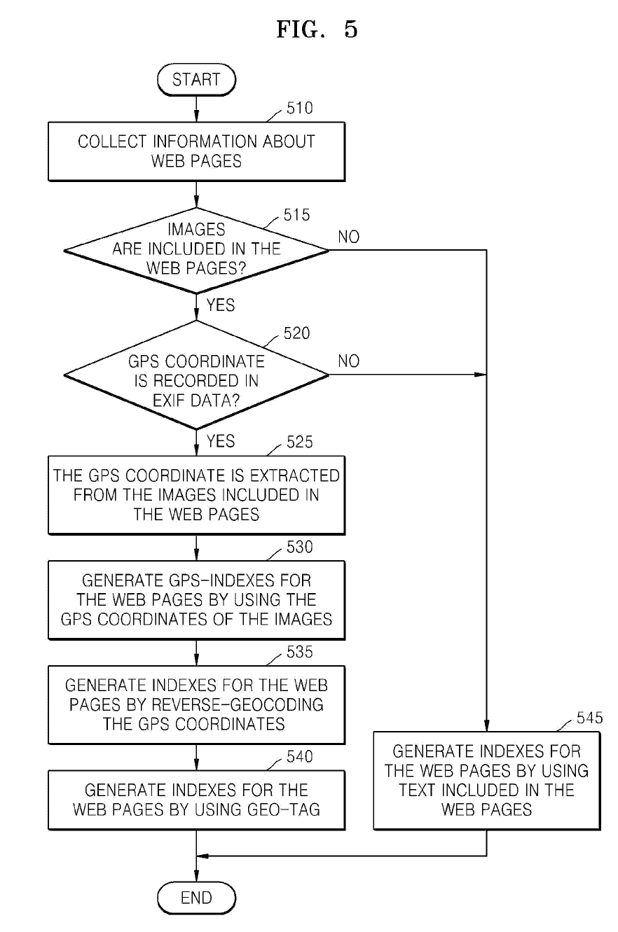

FIG. 5 is a flowchart of a position-based index database generating method performed by a web searching server 110, according to another embodiment of the present invention. Referring to FIG. 5, web pages on the Internet are collected by using a software agent (that is, a program) referred to as a web crawler in operation 510. Here, the web crawler searches for web pages and provides the web pages to a web search engine. It is checked whether images are included in the web pages that are searched for by the web crawler in operation 515.

When the web pages include images (operation 515), it is checked whether GPS coordinate information is recorded in each piece of exchangeable image file format (Exif) data of the images in operation 520. Here, the Exif data indicates information about a photo image digitally captured by a digital camera, and includes GPS coordinate information (e.g., latitude, longitude, and the like) related to the photo image. Conversely, when the web pages do not include the images (operation 515), or when GPS coordinates are not recorded in the Exif data of the images (operation 520), a keyword-index for each of the web pages is generated by using text included in each of the web pages, similar to a conventional web search engine operational manner, in operation 545.

When the web pages include the images having the Exif data with the recorded GPS coordinates (operation 520), the GPS coordinate information is extracted from each of the images included in the web pages in operation 525, and the extracted GPS coordinate information is used to generate a GPS-index for each of the web pages in operation 530. Recently, the number of terminals having installed therein a GPS operation has increased so that GPS coordinates are recorded in Exif data of an image that is digitally photographed by using a digital camera or a mobile phone camera having the GPS operation. Thus, when the web crawler visits a web page and confirms that the web page includes images, GPS coordinates are extracted from Exif data of the images in operation 525.

The GPS coordinates are reverse geocoded to geographic information including a name of an area, an address, a trade name, a street name, and/or the like by using a reverse geocoding algorithm in operation 535. The geographic information is stored in an index database as a geotag for each of the web pages. A geotag-index for each of the web pages is generated by using the geotag, in the same manner as a conventional text-based search engine generates an index for a web page by using text of the web page, in operation 540. In this manner, the web searching server 110 stores the keyword-index for each of the web pages, the GPS-index for each of the web pages, and the geotag-index for each of the web pages in the index database.

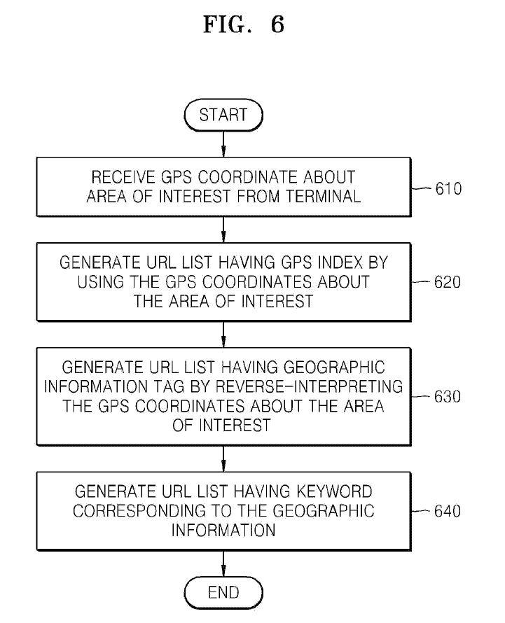

FIG. 6 is a flowchart of a position-information-based web searching method performed by a web searching server 110, according to another embodiment of the present invention. Referring to FIG. 6, a map parameter of an area of interest is received from a terminal 130 in operation 610. Here, the map parameter may be in the form of coordinates on a map or GPS coordinates on the map, though aspects of the present invention are not limited thereto. A URL list of web pages respectively having a GPS index is generated by using the GPS coordinates of the area of interest in operation 620. That is, the GPS coordinates of the area of interest received from the terminal 130 are compared and matched with a GPS-index in a database to generate the URL list of the web pages corresponding to the area of interest.

The GPS coordinates of the area of interest are reverse-interpreted to generate a URL list of web pages having geographic information tags in operation 630. That is, the GPS coordinates of the area of interest are reverse geocoded to geographic information including a name of an area, an address, a trade name, a characteristic of a street, and/or the like by using a reverse geocoding algorithm, the geographic information is compared and matched with the GPS-index in the database, and the URL list of the web pages corresponding to the area of interest is generated accordingly.

Also, a URL list of web pages having a keyword corresponding to the geographic information of the area of interest is generated in operation 640. That is, the keyword of the geographic information is compared and matched with a keyword-index in the database, to generate the URL list of web pages corresponding to the area of interest. At this time, the keyword-index is generated by using a conventional text-based web searching method.

While not restricted thereto, aspects of the invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A web searching method performed by a terminal, the web searching method comprising:
extracting map information about a specific geographic area that is designated via a map displayed on a screen of the terminal;
requesting a server to perform a web search related to the specific geographic area according to the map information;
receiving a link information list from the server and displaying the link information list on the screen, wherein the link information list relates to one or more web pages matched with the map information about the specific geographic area; and
browsing a web page, of the one or more web pages, corresponding to link information selected from the link information list.

2. The web searching method as claimed in claim 1, wherein the specific geographic area is designated as a polygon on the map.

3. The web searching method as claimed in claim 1, wherein the extracting of the map information comprises:
extracting representative map coordinates of the specific geographic area selected by a user; and
converting the representative map coordinates into Global Positioning System (GPS) coordinates.

4. The web searching method as claimed in claim 1, wherein the link information list is arranged, by the terminal, according to a previous web browsing history on the terminal.

5. The web searching method as claimed in claim 1, wherein the link information list is grouped into a plurality of categories.

6. The web searching method as claimed in claim 1, wherein the link information list is displayed on the screen according to a priority order determined by the server.

7. The web searching method as claimed in claim 1, wherein the link information list is classified according to a user's profile and/or a user preference.

8. The web searching method as claimed in claim 7, wherein the user preference is determined according to text in the one or more web pages or from metadata about the one or more web page.

9. A web searching method performed by a server, the web searching method comprising:
collecting a plurality of web pages on the Internet;
extracting position information about each of the plurality of web pages from one or more images comprised in each of the plurality of web pages, and generating a position-based index for each of the plurality of web pages according to the corresponding position information;
comparing the position-based index for each of the plurality of web pages with map information about a specific geographic area selected by a terminal to search for web page link information matching the map information about the specific geographic area in order to generate a link information list about one or more web pages corresponding to the specific geographic area; and
providing the link information list to the terminal.

10. The web searching method as claimed in claim 9, further comprising generating a keyword index for a web page, of the plurality of web pages, according to text comprised in the web page when the web page does not include the one or more images or when Global Positioning System (GPS) coordinates are not recorded in photographed image information of the one of more images of the web page.

11. The web searching method as claimed in claim 9, wherein the generating of the position-based index comprises:
extracting GPS coordinate information from the one or more images comprised in each of the plurality of web pages;
generating a GPS index for each of the plurality of web pages by using the corresponding GPS coordinate information;
reverse-geocoding the GPS coordinate information to geographic information by using a reverse geocoding algorithm; and
setting the geographic information as a geotag for each of the plurality of web pages and generating a geotag-index for each of the plurality of web pages by using the corresponding geotag.

12. The web searching method as claimed in claim 9, wherein the comparing of the position-based index comprises:
comparing GPS coordinate information for each of the plurality of web pages with position information about the specific geographic area selected by the terminal to generate a first link information list about one or more web pages corresponding to the specific geographic area according to the comparing of the GPS coordinate information with the position information;
reverse-geocoding the position information about the specific geographic area to geographic information by using a reverse geocoding algorithm, comparing the geographic information with a geotag-index for each of the plurality of web pages, and generating a second link information list about one or more web pages corresponding to the specific geographic area according to the comparing of the geographic information with the geotag-index; and
comparing a keyword, which corresponds to the geographic information, with a keyword-index of each of the plurality of web pages to generate a third link information list about one or more web pages corresponding to the specific geographic area according to the comparing of the keyword with the keyword-index.

13. The web searching method as claimed in claim 9, wherein the link information list is provided to the terminal according to a priority order determined by using a predetermined algorithm.

14. The web searching method as claimed in claim 9, wherein
the generating of the position-based index comprises:
extracting GPS coordinate information from the one or more images comprised in each of the plurality of web pages, and
generating a GPS index for each of the plurality of web pages by using the corresponding GPS coordinate information, the GPS index being the position-based index; and
the comparing of the position-based index comprises comparing the GPS index for each of the plurality of web pages with the map information about the specific geographic area selected by the terminal to determine the one or more web pages corresponding to the specific geographic area.

15. The web searching method as claimed in claim 9, wherein
the generating of the position-based index comprises:
extracting GPS coordinate information from the one or more images comprised in each of the plurality of web pages,
reverse-geocoding the GPS coordinate information to geographic information by using a reverse geocoding algorithm, and
generating a geo-tag index for each of the plurality of web pages by using the corresponding geographic information, the geo-tag index being the position-based index; and
the comparing of the position-based index comprises comparing the geo-tag index for each of the plurality of web pages with the map information about the specific geographic area selected by the terminal to determine the one or more web pages corresponding to the specific geographic area.

16. The web searching method as claimed in claim 10, wherein the comparing of the position-based index comprises comparing a keyword, which corresponds to the map information, with the keyword-index of the web page to determine if the web page is among the one or more web pages corresponding to the specific geographic area.

17. A terminal for web searching, the terminal comprising:
an input unit to receive an input of a user command;
a storage unit to store map information;
a display unit to display the map information and web page data; and
a control unit to generate a query message according to map coordinates of a specific geographic area that is selected via the input unit from the map information displayed on the display unit, to receive a link information list from a server in response to the query message, and to display the link information list,
wherein the link information list relates to one or more web pages matched with map information about the specific geographic area.

18. The terminal as claimed in claim 17, wherein the control unit arranges the link information list according to a previous web browsing history on the terminal.

19. A server for web searching, the server comprising:
a web page collecting unit to collect a plurality of web pages on the Internet;
a web page index generating unit to extract position information about each of the plurality of web pages from one or more images comprised in each of the plurality of web pages, and to generate a position-based index for each of the plurality of web pages according to the corresponding position information; and
a web searching unit to compare the position-based index for each of the plurality of web pages with map information about a specific geographic area selected by a terminal in order to generate a link information list about one or more web pages, of the plurality of web pages, corresponding to the specific geographic area, when a query message including the specific geographic area is received from the terminal.

20. The server for web searching as claimed in claim 19, wherein the web page index generating unit generates a keyword index for a web page, of the plurality of web pages, according to text comprised in the web page when the web page does not include the one or more images or when Global Positioning System (GPS) coordinates are not recorded in photographed image information of the one of more images of the web page.

21. The server for web searching as claimed in claim 20, wherein the web searching unit compares a keyword, which corresponds to the map information, with the keyword-index of the web page to determine if the web page is among the one or more web pages corresponding to the specific geographic area.

22. The server for web searching as claimed in claim 19, wherein:
the web page index generating unit extracts GPS coordinate information from the one or more images comprised in each of the plurality of web pages, and generates a GPS index for each of the plurality of web pages by using the corresponding GPS coordinate information, the GPS index being the position-based index; and
the web searching unit compares the GPS index for each of the plurality of web pages with the map information about the specific geographic area selected by the terminal to determine the one or more web pages corresponding to the specific geographic area.

23. The server for web searching as claimed in claim 19, wherein:
the web page index generating unit extracts GPS coordinate information from the one or more images comprised in each of the plurality of web pages, reverse-geocodes the GPS coordinate information to geographic information by using a reverse geocoding algorithm, and generates a geo-tag index for each of the plurality of web pages by using the corresponding geographic information, the geo-tag index being the position-based index; and
the web searching unit compares the geo-tag index for each of the plurality of web pages with the map information about the specific geographic area selected by the terminal to determine the one or more web pages corresponding to the specific geographic area.

24. A computer-readable recording medium having recorded thereon a program to execute the method of claim 1 and implemented by at least one computer.
